(19) United States
(12) Patent Application Publication
(10) Pub. No.: US 2021/0026995 A1
(43) Pub. Date: Jan. 28, 2021

(54) ELECTRONIC DEVICE, DISPLAY SYSTEM AND INTEGRATED CONTROL DEVICE THEREOF, AND SECURITY VERIFICATION METHOD

(71) Applicant: Chipone Technology (Beijing) Co., Ltd., Beijing (CN)

(72) Inventors: Dong XU, Beijing (CN); Lei FA, Beijing (CN); Lijie HOU, Beijing (CN); Kun Li, Beijing (CN); Zhenshan Qin, Beijing (CN); JINFANG ZHANG, Beijing (CN)

(73) Assignee: Chipone Technology (Beijing) Co., Ltd., Beijing (CN)

(21) Appl. No.: 16/768,637

(22) PCT Filed: Mar. 29, 2018
(86) PCT No.: PCT/CN2018/081113

§ 371 Date: May 29, 2020

(30) Foreign Application Priority Data
Nov. 30, 2017 (CN) 201711241622.3

(51) Int. Cl. G06F 21/84; G06F 21/32; G06F 21/60; G06F 3/041; G09G 3/36; G09G 3/3225

(52) U.S. Cl. CPC G06F 21/84; G06F 21/32; G06F 21/602; G06F 3/041; G09G 2310/08; G09G 3/3225; G09G 2358/00; G09G 2300/08; G09G 3/36

(57) ABSTRACT

The present application discloses an electronic device, a display system and an integrated control device thereof, and a security verification method. The integrated control device includes: a display unit for providing display driving signals to a display screen; a sensor unit for providing a driving signal to at least one sensor and receiving a sensing signal from the at least one sensor, and converting the sensing signal into sensing data; a processor for controlling the display unit and the sensor unit, wherein the processor performs local security verification to at least a part of the sensing data, and an verification result is output by the integrated control device. The integrated control device has the functions of display driving, touch driving and security verification, thus improving security and saving system resources.

### CROSS-REFERENCE TO RELATED APPLICATIONS

The present application claims the priority of Chinese Patent Application No. 201711241622.3, filed on Nov. 30, 2017 and entitled by “Electronic Device, Display System and Integrated Control Device Thereof, and Security Verification Method”, which is incorporated herein by reference in its entirety.

### FIELD OF TECHNOLOGY

The present application relates to the field of display technology, in particular to an electronic device, display system and integrated control device thereof, and security verification method.

### DESCRIPTION OF THE RELATED ART

With the coming of big data era, the security of massive data becomes a key problem which must be effectively solved in “human-machine interaction” technologies. A display screen of an electronic device is not only used to display an image and/or a text, but is also further developed to be an important path for achieving human-machine interaction. A touch sensor, a fingerprint sensor, an acoustic sensor, an optical sensor and the like can be integrated in a display screen, thus a display system may be formed. A user can directly perform following operations on a display screen: word input, icon selection, gesture control, voice recognition, face recognition and the like.

The display system, serving as an information acquisition input terminal and a displayed content output terminal, plays an irreplaceable and important role for ensuring the security of data interaction. Interactive data acquired by a display screen not only comprise text information inputted via a keyboard, but may also comprise privacy information such as fingerprint, facial features and the like. Sensitive data will be transmitted from a driver chip of the display screen to a processor on a main board, and can be processed by an operating system to realize functions such as security verification and the like.

The above-described prior art that a display system directly supplies sensitive data to an operating system has a potential risk of divulging sensitive data of the user. Performing security verification at a system level is a function of operating systems in most mobile terminals. For example, an Android system provides a fingerprint recognition framework. Only if an application program APP obtains authority for calling identity verification from an operating system, can the application program APP meet requirements to achieve functions such as payment and the like. After a request is received from the application program APP, the operating system acquires a fingerprint, and compares the acquired fingerprint with stored fingerprint feature data to determine user's identity. The application program APP acquires an identity verification result from the operating system. However, a user who uses the application program APP is intend to realize a verification function, but not to intentionally provide his/her sensitive data to the application program APP. If the application program APP is managed to acquire user's sensitive data, then the protection of user privacy would be extremely unfavorable. Some malicious application program APPs can even utilize user's sensitive data to impersonate user's identity, thus generating serious security hazard.

In a further improved system, security verification at hardware level can be adopted. For example, an electronic device may comprise an additional security chip, such that sensitive data can be separately stored and authenticated by the security chip. However, the security chip increases system cost; furthermore, the communication between the security chip and the operating system would reduce system efficiency.

Therefore, it is expected to further improve the security of the display system and improve security verification efficiency of the operating system.

### SUMMARY

In view of the above-described problems, the object of the present disclosure is to provide a display system and an integrated control device thereof, and a security verification method, wherein the integrated control device of a display screen performs security verification, so as to improve security and save system resources.

According to a first aspect of the present disclosure, an integrated control device is provided and comprises: a display unit, configured to provide display driving signals to a display screen; a sensor unit, configured to provide a driving signal to at least one sensor, receive a sensing signal from the at least one sensor, and convert the sensing signal into sensing data; and a processor, configured to control the display unit and the sensor unit, wherein the processor is configured to perform local security verification on at least a part of the sensing data, and an verification result is output by the integrated control device.

Preferably, the integrated control device further comprises: a non-volatile memory configured to store feature data, wherein the processor is configured to perform security verification by comparing the sensing data with the feature data.

Preferably, the display unit is used to drive a liquid crystal display screen, and comprises: a display and graphic interface, configured to receive display data; a display controller, configured to generate image data according to the inputted display data; a graphic engine, configured to provide an optimized image corresponding to the at least one sensor; a gate driving module, configured to generate gate voltages to selectively turn on multiple rows of thin film transistors; a source driving module, configured to generate gray scale voltages according to the image data, and apply the gray scale voltages via the selected thin film transistors which are turned on; and a timing controller, configured to control output time of the gate voltages and the gray scale voltages, for selectively turning on the multiple rows of thin film transistors in a scanning manner during continuous image frame periods.

Preferably, the display unit further comprises: a common voltage driving module, configured to generate a common voltage; and a gamma reference module, configured to store a gamma correction curve, and provide a correction signal to the source driving module for correcting the gray scale voltages, so as to satisfy a nonlinear requirement of human eyes under luminance change.

Preferably, the display unit is used to drive an AMOLED display screen, and comprises: a display and graphic interface, configured to receive display data; a display controller, configured to generate image data according to the inputted display data; a graphic engine, configured to provide an optimized image corresponding to the at least one sensor; a row driving module, configured to generate gate voltages to selectively turn on multiple rows of thin film transistors; a column driving module, configured to generate gray scale voltages according to the image data, and apply driving currents corresponding to the gray scale voltages via the selected thin film transistors which are turned on; and a timing controller, configured to control output time of the gate voltages and the gray scale voltages, for selectively turning on the multiple rows of thin film transistors in a scanning manner during continuous image frame periods.

Preferably, the display unit further comprises: a gamma reference module, configured to store a gamma correction curve, and provide a correction signal to the column driving module for correcting the gray scale voltages, so as to satisfy a nonlinear requirement of human eyes under luminance change.

Preferably, the at least one sensor is selected from at least one of a touch sensor, a fingerprint sensor, a palm print sensor, an acoustic sensor and an optical sensor; and the sensing data is used to represent at least one of a two-dimensional code, a touch position, a fingerprint, a palm print, a voice print and an iris.

Preferably, the at least one sensor is a touch sensor; and the sensor unit comprises: a touch logic module, configured to provide touch driving signals, receive touch sensing signals, and perform amplification and digital-to-analog conversion on the received touch sensing signal to generate the sensing data; and a touch interface, configured to send the sensing data and one of the verification result and encrypted data generated according to the sensing data out of the integrated control device.

Preferably, the integrated control device is a single chip.

According to a second aspect of the present disclosure, a display system is provided and comprise: a display screen, configured to display an image according to display data; at least one sensor, configured to acquire a sensing signal by interacting with a user; and the integrated control device described in the present disclosure.

Preferably, the display screen is selected from any one of a liquid crystal display screen, an LED display screen, an AMOLED display screen, a quantum dot display screen, electronic paper and a Micro-LED display screen.

Preferably, the at least one sensor is located inside or outside the display screen.

According to a third aspect of the present disclosure, an electronic device is provided and comprises: at least one sensor, configured to acquire a sensing signal by interacting with a user; and the integrated control device described in the present disclosure.

Preferably, the electronic device is selected from any one of a mobile phone, a tablet computer, a notebook computer, a VR device, an AR device, a watch, an automobile and a bicycle.

According to a fourth aspect of the present disclosure, a security verification method is provided and comprises: acquiring a sensing signal from at least one sensor; acquiring sensing data from the sensing signal; and encrypting at least a part of the sensing data to obtain encrypted data, or performing local security verification to obtain an verification result.

Preferably, before the step of performing local security verification, the method further comprises: obtaining an identifier from the at least one sensor; and determining whether the sensing data is sensitive data according to the identifier, wherein at least a part of the sensing data is sensitive data.

Preferably, before the step of performing local security verification, the method further comprises: setting a display screen to operate under a predetermined operating status; detecting the operating status of the display screen; and distinguishing the sensing data into sensitive data and non-sensitive data according to the detected operating status.

Preferably, before the step of performing local security verification, the method further comprises: distinguishing the sensing data into first level sensitive data and second level sensitive data according to sensitivity levels, wherein at least a part of the sensing data is the second level sensitive data, and the sensitivity level of the second level sensitive data is higher than that of the first level sensitive data.

Preferably, the method further comprises: packaging one of the sensing data, the encrypted data and the verification result into a data packet, and transmitting the data packet.

Preferably, a start flag and a type identifier are added before data content to be packaged, and an end flag and a check flag are added after the data content to be packaged.

Preferably, the security verification comprises: comparing the sensing data with feature data to obtain a comparison result.

Preferably, the method further comprises: obtaining the feature data from outside of the integrated control device in advance.

Preferably, before the step of performing local security verification, the method further comprises: locally obtain and generate the feature data by use of the at least one sensor.

In the display system according to the embodiments of the present disclosure, the processor in the integrated control device has the functions of display driving, touch driving and security verification. After the processor acquires the sensing data from the touch logic module, the processor executes different data processing process according to the type of the sensing data. Therefore, the transmitted data supplied by the touch interface not only can be a single type sensing data, but also can be one of the sensing data, the encrypted data and the verification result.

The processor of the integrated control device locally performs security verification on the sensitive data, and is not required to transmit the sensitive data out of the display system, thus improving security. The integrated control device does not need to include a separate security chip, and can still perform security verification at hardware level without increasing hardware cost.

Compared with existing techniques, the integrated control device can reduce the structural size of the display module, can reduce the number of electronic elements, reduce design complexity, and improve finished product rate.

In a preferable embodiment, the modules of the integrated control device are integrated in a single chip. Further, a flash memory can also be integrated in the chip of the integrated control device. The feature data is locally stored in the chip, therefore, the security can be further improved.

### BRIEF DESCRIPTION OF THE DRAWINGS

The above and other objects, features and advantages of the present disclosure will become more apparent from the description below with reference to the accompanying drawings.

FIG. 1 shows an equivalent circuit diagram of a liquid crystal display device in a display system according to an embodiment of the present disclosure;

FIG. 2 shows an equivalent circuit diagram of a touch device in a display system according to an embodiment of the present disclosure;

FIG. 3 is a schematic view showing an internal structure of a display system according to an embodiment of the present disclosure;

FIG. 4 is a schematic view showing circuit connections of a display system according to an embodiment of the present disclosure;

FIG. 5 shows a schematic block diagram of an integrated control device in a display system according to an embodiment of the present disclosure;

FIG. 6 shows a schematic block diagram of another integrated control device in a display system according to an embodiment of the present disclosure;

FIG. 7 shows a timing diagram of performing display and touch in a time division multiplexing manner in a display system according to an embodiment of the present disclosure; and

FIG. 8 shows a flow chart of a security verification method executed in a display system according to an embodiment of the present disclosure.

### DESCRIPTION OF THE EMBODIMENTS

The present disclosure will be described in more detail below with reference to the accompanying drawings. In the various figures, same elements are denoted by similar reference numerals. For the sake of clarity, various parts in the figures are not drawn to scale. In addition, some commonly known parts may not be shown.

In order to make the present disclosure much clearly understood, a large number of specific details of the present disclosure are described hereafter, for example, the structure, material, size, processing process and technology of the device. However, as can be understood by a person skilled in the art, the present disclosure may be realized without the specific details described below.

In the present application, the term “local” or “locally” denotes that an object is disposed in a chip of the integrated control device at a display screen terminal, or is located together with the integrated control device on a same printed circuit board. For example, “local verification” denotes that an verification program is executed by a processor in the chip of the integrated control device; and “local memory” denotes that a non-volatile memory for storing feature data, an encryption program and an verification program is located in the chip of the integrated control device, or is located together with the integrated control device, on a same printed circuit board.

The present disclosure can be embodied in various forms, some of which are described below.

The display system according to an embodiment of the present disclosure comprises a display device, and at least one sensor for acquiring user information. The display device, for example, is selected from any one of a liquid crystal display screen, an LED display screen, an AMOLED display screen, a quantum dot display screen, electronic paper and a Micro-LED display screen. Each one of the at least one sensor, for example, is selected from any one of a touch device, a fingerprint sensor, an optical sensor, and an acoustic sensor. The following embodiments are described by taking a touch liquid crystal display screen as an example, wherein the display device is a liquid crystal display device, and the sensor is a touch device.

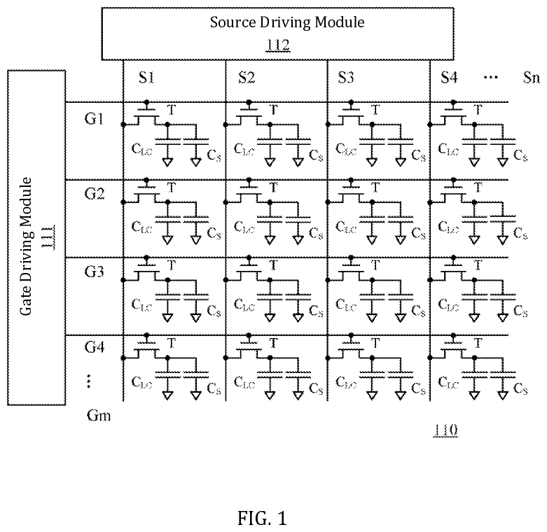

FIG. 1 shows an equivalent circuit diagram of the liquid crystal display device in a display system according to an embodiment of the present disclosure.

The liquid crystal display device 110 comprises a gate driving module 111, a source driving module 112, a plurality of thin film transistors T, and a plurality of pixel capacitors C_{LC}, each pixel capacitor is formed between a pixel electrode and a common electrode. The plurality of thin film transistors T form an array. The gate driving module 111 is connected to gate electrodes of the thin film transistors T arranged in a corresponding row, respectively, via a plurality of gate scanning lines, and is used to supply gate voltages G1 to Gm in a scanning manner, so as to selectively turn on different rows of the thin film transistors in one image frame period. The source driving module 112 is connected to source electrodes of the thin film transistors T arranged in a corresponding column, respectively, via a plurality of source data lines, and is used to supply gray scale voltages S1 to Sn corresponding to gray scales to columns of thin film transistors T when each row of the thin film transistors T are selected to be turned on, wherein m and n are natural numbers. A drain electrode of each thin film transistor T is connected to the corresponding pixel capacitor C_{LC}.

The source driving module 112 applies the gray scale voltages on corresponding the pixel capacitors C_{LC} via the source data lines and the selected thin film transistors T which are under turn-on state. The voltage on the pixel capacitors C_{LC} acts on liquid crystal molecules, such that the alignment of the liquid crystal molecules is changed, so as to realize a light transmittance corresponding to the gray scales. In order to hold the voltages between pixel updating periods, each of the pixel capacitors C_{LC} can be connected to a storage capacitor Cs in parallel to keep a longer holding time.

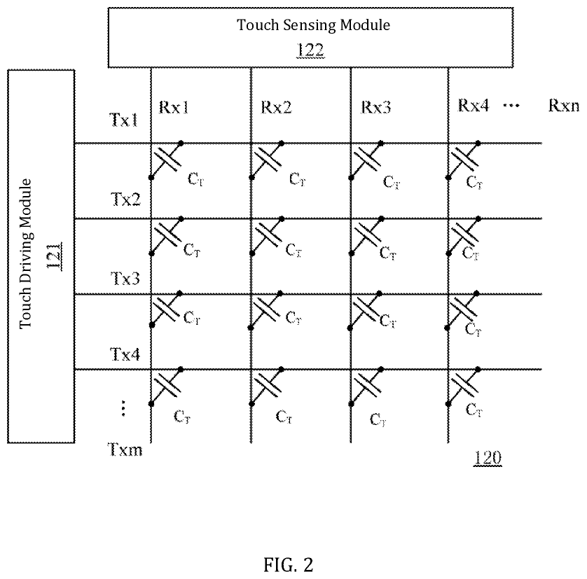

FIG. 2 shows an equivalent circuit diagram of the touch device in a display system according to an embodiment of the present disclosure;

The touch device 120 comprises a touch driving module 121, a touch sensing module 122, and a plurality of sensing capacitors CT each of which formed between an exciting electrode and a sensing electrode, wherein the plurality of sensing capacitors CT form an array. The touch driving module 121 is connected to all rows of the exciting electrodes, and is used to provide exciting signals Tx1 to Txm in a scanning manner, so as to sequentially provide exciting signals to different rows of exciting electrodes in one touch frame period. The touch sensing module 122 is connected to all columns of the sensing electrodes, and is used to obtain receiving signals Rx1 to Rxn from corresponding columns, wherein m and n are natural numbers.

The touch driving module 121, for example, generates alternating-current electrical signals as the exciting signals; the touch sensing module 122, for example, receives the alternating-current electrical signals, detects the current values according to the received signals, and further acquires a capacitance value of an intersection point of one of the driving electrode and one of the sensing electrode according to the current values, so as to determine whether a touch action occurs at the point.

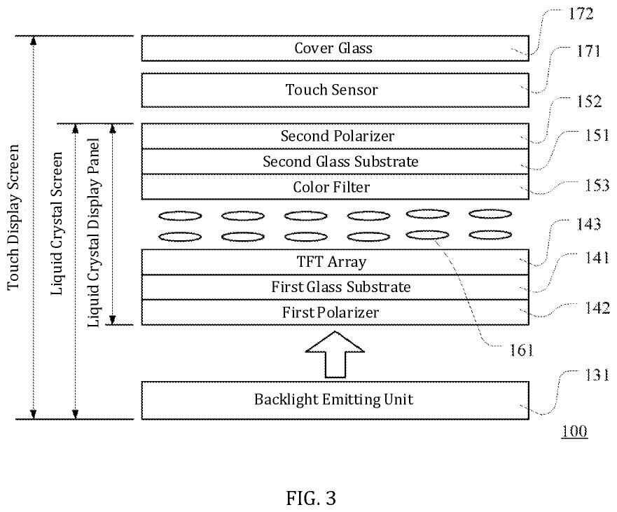

FIG. 3 is a schematic view showing an internal structure of a display system according to an embodiment of the present disclosure. In the embodiment, the display system is a touch display screen 100.

As shown in the figure, the touch display screen 100 comprises a liquid crystal display screen, and a touch sensor 171 and a cover glass 172 which are sequentially stacked on the liquid crystal display screen. The liquid crystal display screen comprises a backlight emitting unit 131 for providing backlight, and a liquid crystal display panel for changing light transmittance according to gray scale signals. The touch sensor 171 uses, for example, a plastic plate as a substrate.

The liquid crystal display panel further comprises a first glass substrate 141, a second glass substrate 142, and a liquid crystal layer 161 sandwiched between the two glass substrates 141 and 142, wherein the first glass substrate 141, the second glass substrate 142, and the liquid crystal layer 161 sequentially face each other; a first polarizer 142 and a TFT array 143 are formed on the first glass substrate 141; a second polarizer 152 and a color filter 153 are formed on the second glass substrate 142.

A plurality of gate scanning lines, a plurality of source data lines and a plurality of pixel electrodes are also formed on the first glass substrate 141; the TFT array 143 comprises a plurality of thin film transistors; the gate electrode of each thin film transistor is connected to a corresponding gate scanning line; the source electrode of each thin film transistor is connected to a corresponding source data line; and the drain electrode of each thin film transistor is connected to a corresponding pixel electrode. A pixel capacitor is formed between a corresponding pixel electrode and a corresponding common electrode. As described below, the liquid crystal display panel further comprises a driver chip, wherein a gate driving module and a source driving module in the driver chip respectively provide gate voltages and gray scale voltages.

The source driving module applies the gray scale voltages on the pixel capacitors C_{LC} via the source data lines and the selected thin film transistors which are under turn-on state. The voltage on the pixel capacitors C_{LC} acts on liquid crystal molecules, such that the alignment of the liquid crystal molecules is changed, so as to realize a light transmittance corresponding to the gray scales for displaying based on the gray scales.

In the embodiment, a “Sensor-on-Lens, SoL” touch display screen 100 having a sensor externally embedded with a cover glass is shown to describe a basic principle of the present disclosure. However, the present disclosure can be applied to touch display screens with various structures, but not limited to the type of sensor and the integration form thereof in a display screen.

With the design method, the touch sensor 171 can be either added on the cover glass (CG), or placed in a special sensor layer. The method of combining the touch sensor 171 on the cover glass is sometimes called as “sensor-on-lens, SoL” or “one glass solution, OGS”. Therefore, the method does not need to add a separate sensor layer; instead, the cover glass is functional enough. The design method adopting a separate touch sensor 171 is called as glass-film (GF) or glass-film-film (GFF), wherein the former adopts a single layer of electrode, and the latter adopts two layers of electrodes. The design methods are all called as “separate” methods, namely the touch sensor 171 is stacked, as a separate structure, on the surface of the liquid crystal display screen. A separate touch sensor cover layer has advantages of mature technology, low risk, and quick product marketing speed. The latest display and touch technology also adopts the separate design, under which situation the separate design is generally integrated in a subsequent design process.

In a further improved structure, the electrode array of the touch sensor 171 is directly integrated on one layer or multiple layers of the liquid crystal display screen. The integration can be realized on or in a basic cell of the display screen, namely on-cell integration or in-cell integration.

The method of disposing the touch electrode array on the second glass substrate 151 is called as On-Cell integration because the sensor is located on a basic cell of the display screen. Driving electrodes and receiving electrodes of the sensor can be electrically separated from jumper wires, and can also adopt a special layout, such that the network can be realized without a bridge. The latter design is called as single-layer-on-cell (SLOC) and is commonly used owing to low cost and high product yield.

Adopting the on-cell technology to add a touch function to a display screen is simple and reliable. Furthermore, the method is often the best selection for an active-matrix organic light emitting diode (AMOLED) display screen. For a display screen with large display panel, curved display panel or flexible display panel, integrating a metallic reticulated sensor with no jumper wire by on-cell technology is also a good choice.

The in-cell integration is a mixed design, wherein the driving electrodes of the touch sensor are embedded in the first glass substrate 141, and the receiving electrodes are disposed on the second glass substrate 151. Such a design is called as hybrid in-cell design. In order to avoid confusion, the term “full in-cell” refers to that the driving electrodes and the receiving electrodes are both located in basic cells.

In the embodiment, the touch sensor is integrated in the display system. In an alternative embodiment, other than the touch sensor, various biological/optical sensors can also be integrated, such as a fingerprint sensor, an acoustic sensor, an optical sensor and the like for acquiring a fingerprint, a voice print, an iris and other biometric information.

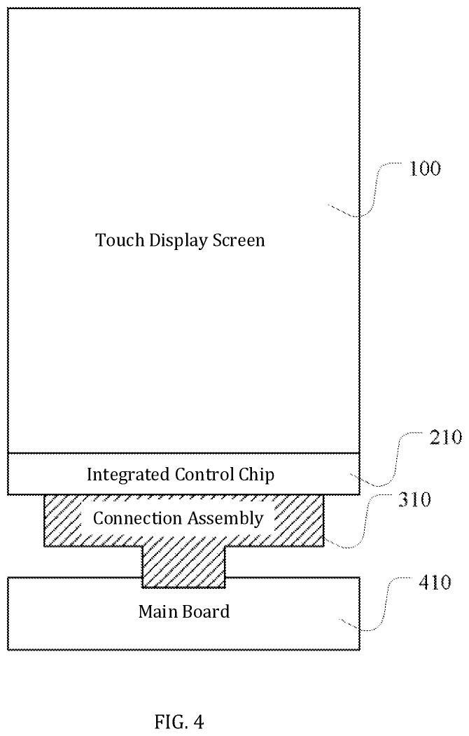

FIG. 4 is a schematic view showing circuit connections of the display system according to an embodiment of the present disclosure. In the embodiment, the display system is a touch display screen 100. The touch screen 100 further comprises an integrated control chip 210, wherein the integrated control chip is used to provide display driving signals, comprising gate voltages and gray scale voltages, to the thin film transistors in the liquid crystal display screen, controls touch driving signals for the driving electrodes in the touch sensor, and acquires receiving signals from the receiving electrodes in the touch sensor, to determine a touch position. The integrated control chip 210 is connected to a main board 410 via a connection assembly 310. The connection assembly 310, for example, is a flexible circuit board. The main board 410 comprises a main processor, for realizing a function of an operating system.

In the display system in the prior art, the acquired sensitive data is transmitted from the display system 100 to the main processor of the main board 410. After the operating system receives a request from an application program APP, the operating system compares the sensitive data with stored feature data to determine the identity of the user, thus realizing the security verification function. The application program APP acquires an identity verification result from the operating system.

In the display system according to the embodiment, the integrated control chip 210 stores the feature data, performs security verification, and does not need to transmit the sensitive data out of the display system 100, thus improving security. The display system does not need to provide a separate security chip, and can still perform security verification at hardware level without increasing hardware cost. Even if an application program App is managed to access the operating system, the application program App still cannot acquire the sensitive data from the integrated control chip 210 on the basis of the operating system.

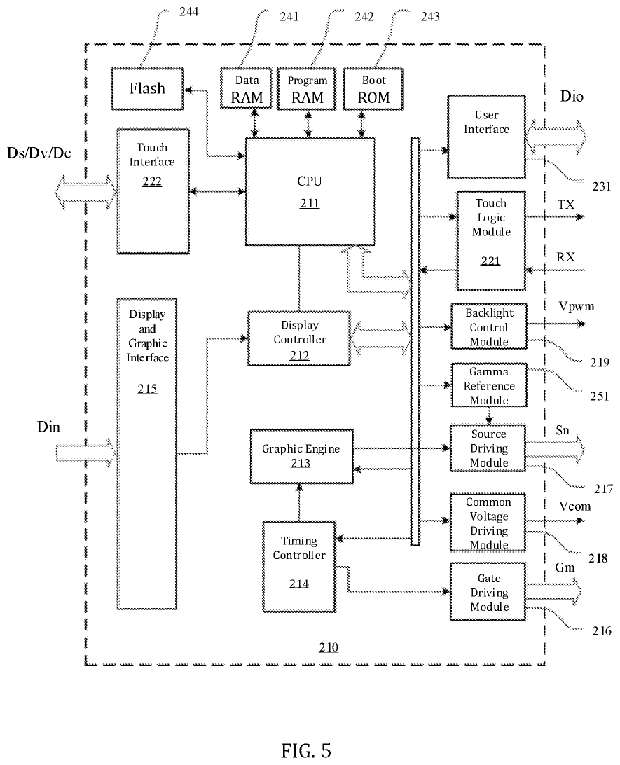

FIG. 5 shows a schematic block diagram of one integrated control device in the display system according to an embodiment of the present disclosure. The display system, for example, has a liquid crystal display screen.

As shown in the figure, the integrated control chip 210 comprises a processor 211, a user interface 231, a storage unit, a display unit and a touch unit.

The processor 211 is a Von Neumann or Harvard architecture RISC CPU, including but not limited to ARM, MIPS, OPEN RISC and the like, preferably ARM, and can also be DSP and the like. The processor 211 can optimize touch detecting sensor or other types of sensors, and can locally process touch inputs to determine whether the operating system is required to be wakened to handle a user request.

The user interface 231 may support multiple communication protocols and digital I/O, such as I2C protocol and SPI protocol, and may provide a plurality of digital I/O pins. The user interface 231 can mutually communicate with the main processor on the main board.

The storage unit further comprises a data RAM 241, a program RAM 242, a boot ROM 243, and a flash memory 244. The flash memory 244 stores the feature data, an encryption program and an verification program. While the integrated control chip 210 is powered on, a bootstrap program in the boot ROM 243 detects the flash memory 244, uploads the encryption program and the verification program from the flash memory 244, performs decryption and stores data in the program RAM. The data generated in the operating process of the processor 211 can be stored in the data RAM 241. In the embodiment, the feature data in the flash memory 244 can be derived from the main processor on the main board, and can also be obtained by local acquisition and data processing under control of the processor 211. Under the latter situation, both the sensitive data of the user and the feature data are locally generated. The operating system can only acquire the verification result from the integrated control chip 210, but cannot acquire both of the sensitive data and the feature data, thus facilitating further improvement of security.

The display unit comprises a display controller 212, a graphic engine 213, a timing controller 214, a display and graphic interface 215, a gate driving module 216, a source driving module 217, a common voltage driving module 218, a backlight control module 219, and a gamma reference module 251. The display controller 212 is configured to generate image data according to inputted display data. The graphic engine 213 is used to control an internal memory window, a cursor, a pointer and a sprite graphic, so as to provide optimized images for touch technology with high performance. The display and graphic interface 215 provides a plurality of industrial standard display interfaces, and is used to receive the display data, such as DSI TCVR, DBI I/F, and DPI I/F. The backlight control module 219 is used to control the backlight of the liquid crystal display screen and realize low power consumption management, and can be combined with an existing backlight energy saving technology. The gate driving module 216, the source driving module 217 and the common voltage driving module 218 are respectively used to generate gate voltages, gray scale voltages and a common voltage. The timing controller 214 is used to control the output time of the gate voltages and the gray scale voltages, supply gate voltages G1 to Gm in a scanning manner in one image frame period, supply gray scale voltages S1 to Sn corresponding to gray scales to columns of the thin film transistors T when the thin film transistors arranged in a corresponding row are selected to be turned on, and apply voltages on pixel capacitors to change the alignment of liquid crystal molecules, so as to control light transmittance corresponding to the gray scales. The gamma reference module 251 is used to store a gamma correction curve, and provide a correction signal to the source driving module 217 to correct the gray scale voltages, so as to satisfy a nonlinear requirement of human eyes under luminance change.

The touch unit comprises a touch logic module 221 and a touch interface 222. The touch logic module 221 has the functions of both the touch driving module and the touch sensing module, and thus can provide touch driving signals TX and receive touch sensing signals RX. The touch logic module 221 is used to perform amplification and digital-to-analog conversion on the received touch sensing signals to generate sensing data. The touch interface 222 supplies the sensing data to the main processor on the main board for further processing via the operating system.

The integrated control device according to the prior art is used to realize at least one of a display driving function and a touch driving function. The CPU in the integrated control device may have both the display driving function and the touch driving function. In the integrated control device, the CPU acquires the sensing data from the touch logic module, and then directly supplies the sensing data to the touch interface, so as to transmit a single type sensing data out of the display screen. The processor on the main board acquires the sensing data, and further wakens the operating system to authenticate the sensing data. In the prior art, the integrated control device does not distinguish a sensitive program using the sensitive data; and the operating system directly acquires the sensitive data.

Different from the integrated control device in the prior art, in the embodiment, the processor 211 in the integrated control chip 210 has the functions of display driving, touch driving and security verification. In a preferred embodiment, the modules of the integrated control chip 210 are integrated in a single chip, thus improving security. However, the present disclosure is not limited to the advantages described herein. The integrated control chip 210 may comprises a plurality of chips which can be together arranged on a circuit board at the display screen terminal. After the processor 211 acquires the sensing data from the touch logic module 221, the processor executes different data processing according to the type of the sensing data. Therefore, the transmitted data supplied by the touch interface 222 is not only the single type sensing data, but also can be one of the sensing data, the encrypted data and the verification result.

In the embodiment, the flash memory 244 of the integrated control chip 210 is used to store the feature data, the encryption program and the verification program. However, the present disclosure is not limited to the advantages described herein. In an alternative embodiment, the integrated control chip 210 can comprise any type of non-volatile memories, such as any one of flash memory, SRAM, DRAM, EEPROM and EPROM.

The flash memory 244 of the integrated control chip 210 is used to locally store the feature data; the processor 211 is used to locally perform security verification without transmitting the sensitive data out of the display system 100, thus improving security. The integrated control chip 210 does not need to provide a separate security chip, and can still perform security verification at hardware level without increasing hardware cost.

In the embodiment, the flash memory 244 is integrated in the integrated control chip 210 to improve security. In an alternative embodiment, the flash memory 244 can be located outside the integrated control chip 210, and is connected to the integrated control chip 210 via a bus, so as to reduce system cost.

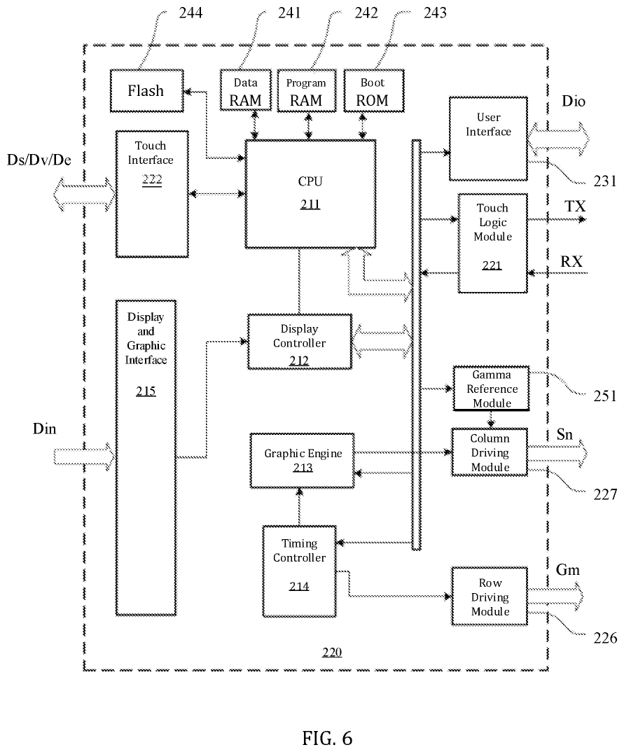

FIG. 6 shows a schematic block diagram of another integrated control device in the display system according to an embodiment of the present disclosure. The display system, for example, has an AMOLED display screen.

As shown in the figure, the integrated control chip 220 comprises a processor 211, a user interface 231, a storage unit, a display unit and a touch unit.

The processor 211 is a Von Neumann or Harvard architecture RISC CPU, including but not limited to ARM, MIPS, OPEN RISC and the like, preferably ARM, and can also be DSP and the like. The processor 211 can optimize touch detecting sensor or other types of sensors, and can locally process touch inputs to determine whether the operating system is required to be wakened to handle a user request.

The user interface 231 may support multiple communication protocols and digital I/O, such as I2C protocol and SPI protocol, and may have a plurality of digital I/O pins. The user interface 231 can mutually communicate with the main processor on the main board.

The storage unit further comprises a data RAM 241, a program RAM 242, a boot ROM 243, and a flash memory 244. The flash memory 244 stores the feature data, an encryption program and an verification program. While the integrated control chip 220 is powered on, a bootstrap program in the boot ROM 243 detects the flash memory 244, uploads the encryption program and the verification program from the flash memory 244, performs decryption and stores data in the program RAM. The data generated in the operating process of the processor 211 can be stored in the data RAM 241. In the embodiment, the feature data in the flash memory 244 can be derived from the main processor on the main board, and can also be obtained by local acquisition and data processing under control of the processor 211. Under the latter situation, both the sensitive data of the user and the feature data are locally generated. The operating system can only acquire the verification result from the integrated control chip 220, but cannot acquire both of the sensitive data and the feature data, thus facilitating the further improvement of security.

The display unit comprises a display controller 212, a graphic engine 213, a timing controller 214, a display and graphic interface 215, a row driving module 226, a column driving module 227, and a gamma reference module 251. The display controller 212 is used to generate image data according to inputted display data. The graphic engine 213 is used to control an internal memory window, a cursor, a pointer and a sprite graphic, so as to supply optimized images for touch technology with a high performance. The display and graphic interface 215 provides a plurality of industrial standard display interfaces, and is used to receive the display data, such as DSI TCVR, DBI I/F, and DPI I/F. The row driving module 226 and the column driving module 227 are respectively used to generate gate voltages and gray scale voltages. The timing controller 214 is used to control the output time of the gate voltages and the gray scale voltages, supply gate voltages G1 to Gm in a scanning manner in one image frame period, supply gray scale voltages S1 to Sn corresponding to gray scales to columns of the thin film transistors T when the thin film transistors arranged in a corresponding row are selected to be turned on, and apply currents corresponding to the gray scale voltages on light emitting diodes to drive the light emitting diodes to emit light, so as to control luminous intensity corresponding to the gray scales. The gamma reference module 251 is used to store a gamma correction curve, and provide a correction signal to the column driving module 227 to correct the gray scale voltages, so as to satisfy a nonlinear requirement of human eyes under luminance change.

The touch unit comprises a touch logic module 221 and a touch interface 222. The touch logic module 221 has the functions of both the touch driving module and the touch sensing module, and thus can supply touch driving signals TX and receive touch sensing signals RX. The touch logic module 221 is used to perform amplification and digital-to-analog conversion on the received touch sensing signals to generate sensing data. The touch interface 222 supplies the sensing data to the main processor on the main board for further processing via the operating system.

In the embodiment, the processor 211 in the integrated control chip 220 has the functions of display driving, touch driving and security verification. After the processor 211 acquires the sensing data from the touch logic module 221, the processor executes different data processing according to the type of the sensing data. Therefore, the transmitted data supplied by the touch interface 222 may not only be the single type sensing data, but can be one of the sensing data, the encrypted data and the verification result.

The flash memory 244 of the integrated control chip 220 is used to locally store the feature data; the processor 211 is used to locally perform security verification without transmitting the sensitive data out of the display system 100, thus improving security. The integrated control chip 220 does not need to include a separate security chip, and can still perform security verification at hardware level without increasing hardware cost.

In the embodiment, the flash memory 244 is integrated in the integrated control chip 220 to improve security. In an alternative embodiment, the flash memory 244 can be located outside the integrated control chip 220, and is connected to the integrated control chip 220 via a bus, so as to reduce system cost.

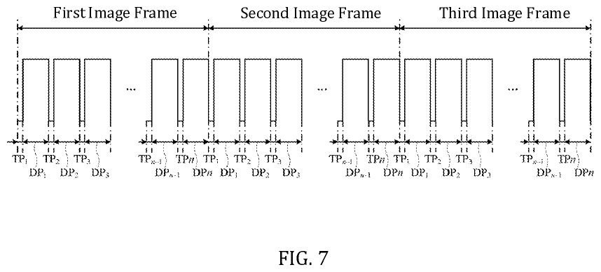

FIG. 7 shows a timing diagram of performing display and touch in a time division multiplexing manner in the display system according to an embodiment of the present disclosure.

In practical applications, the display system can integrate various types of sensors. The processor in the integrated control chip 210 has three functions: display driving, sensor driving and security verification, thus achieving security verification mechanism at hardware level. Various sensing units operate at a low frequency in a periodically polling state.

For touch detection, when a sensing unit senses a touch of an object, the sensing unit is switched to an operating status, and acquires touch data, in which case the display data and the touch data are processed a time division multiplexing manner.

For contact biometric recognition, such as fingerprint recognition, touch action is required by the contact biometric recognition. Therefore, the biometric data obtained by this method is similar to the touch data; the biometric data and the display data can be processed in the time division multiplexing manner.

For non-contact biometric recognition, the acquisition of biometric data can be preset. For the acquisition requiring manual supervision, serial data frames can be adopted to switch the display data to be the currently acquired data; after the currently acquired data is displayed completely, an original picture to be displayed is switched back. If the acquisition process of the non-contact biometric data does not require manual supervision (unsupervised), then the non-contact biometric data and the display data can be processed in background in the time division multiplexing manner. If an image sensor is adopted to acquire an image and it is required to be manually checked whether the image acquired in real time satisfies a requirement, then an object being captured currently can be displayed, and the display data is the currently acquired data of the image sensor.

The situation that touch and display are required to be synchronously performed is taken as an example for description.

In a blanking interval during image frame switching, the display unit has a small noise influence on the touch unit. Therefore, during practical operation of the device, display and touch adopt the time division multiplexing principle; display data processing and touch data processing can be separated in time, so as to reduce mutual interference. During image frame scanning, some time slots are separated out as touch frames.

As shown in FIG. 7, one image frame period may comprise a plurality of display time periods TP and a plurality of touch time periods TP. The display data and the touch data re alternately processed in different time periods. Namely, display and touch are time-division-multiplexed. Human eyes have a recognition time window for picture transformation; therefore, there is a certain requirement on frame rate and the time ratio of the two time periods. Such a driving method can effectively reduce the influence of a noise electrical signal from a liquid crystal display array on the touch operating layer, and can save a shielding layer, thus reducing the thickness of the touch screen.

The time division multiplexing function can be operated by a software program, and can also be realized by combining a MUX multiplexing selection unit.

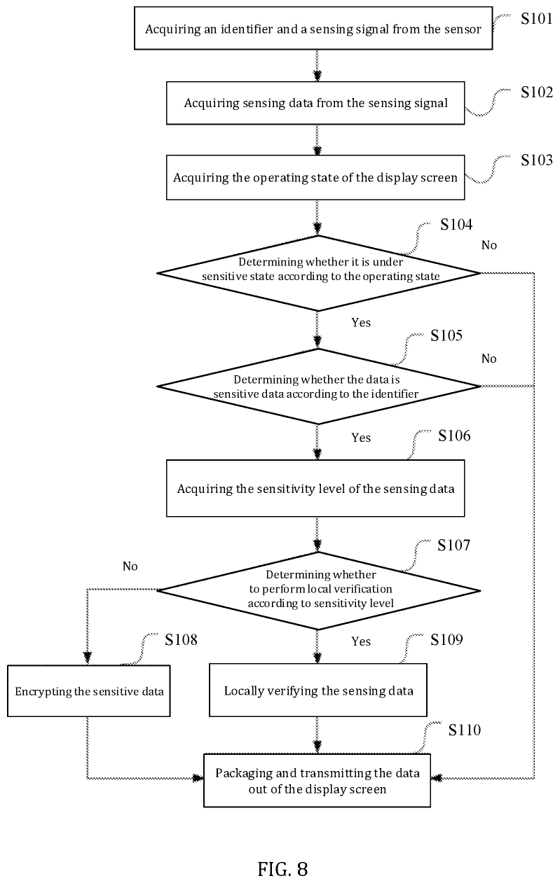

FIG. 8 shows a flow chart of a security authentication method executed in the display system according to an embodiment of the present disclosure. The method describes how the integrated control device is connected to at least one sensor to acquire sensing data, and how to process different data according to the sensitivity level of the sensing data. The sensor, for example, is at least one of a touch sensor, a fingerprint sensor, an acoustic sensor and an optical sensor; and the sensing data, for example, represent at least one of a two-dimensional code, a touch position, a fingerprint, a voice print and an iris.

The security verification method, for example, is applied to the integrated control chip 210 as shown in FIG. 5. In the following embodiment, the steps are also described by taking the touch sensor as an example.

In step S101, the integrated control chip 210 acquires an identifier and a sensing signal from the sensor. The identifier of the sensor is used to identify the type of the sensor.

In the embodiment, different pins of the integrated control chip 210 are connected to different types of sensors; and the identifier of each sensor is acquired via the pins. In an alternative embodiment, the sensor transmits the identifier and the sensing signal together to the integrated control chip 210.

Then, subsequent steps S102 to S110 are executed in the integrated control chip 210.

In step S102, the sensing signal is processed to be sensing data. For example, the touch logic module 211 is used to perform amplification and digital-to-analog conversion on the received signals RX to generate the sensing data.

In step S103, as a preferred step, the operating status of the touch display screen 110 is acquired.

Various operations can be performed on the touch display screen 110. Even a same action of the user may generate sensitive data or non-sensitive data under different situations. For example, when the screen is unlocked or an application program APP requests to unlock the screen, the operating system generates a password input interface on the touch display screen 110, and then user's touch action generates an input password. The input password is private content which can be considered to be sensitive data. On the contrary, when an image zooming operation is performed on an application program APP, user's touch actio generates a zooming instruction. The zooming instruction is non-private content which can be considered to be non-sensitive data.

In the step, the display screen is already set to operate under a predetermined operating status, which is, for example, a sensitive state or a non-sensitive state. The integrated control chip 210 already activate the sensor to acquire sensing data in the preceding steps. Further, the integrated control chip 210 can detect the operating status of the touch display screen 110 through the operating system, such that whether the sensing data is sensitive data can be determined subsequently.

In step S104, whether the touch display screen 110 is operated in the sensitive state is determined according to the detected operating status of the touch display screen 110. If the operating status of the touch display screen 110 is detected to be the non-sensitive state, then step S110 is executed to package and transmit the sensing data out of the display screen. If the operating status of the touch display screen 110 is detected to be the sensitive state, then step S105 is executed.

In step S105, whether the sensing data is sensitive data is determined according to the identifier. If the sensing data acquired by the touch display screen 110 is non-sensitive data, then step S110 is executed to package and transmit the sensing data out of the display screen. If the sensing data acquired by the touch display screen 110 is sensitive data, then step S106 is executed.

For example, as described above, the sensing data generated by the touch sensor is associated with the operating status, and may be non-sensitive data or sensitive data. The sensing data generated by a fingerprint sensor is always sensitive data.

In step S106, the sensitivity level of the sensing data is acquired. For example, the sensing data generated by a touch sensor, for example, is used to input a user name and identity card information, and is further processed by the operating system; the sensitivity level of the sensing date can be considered to be first level. The sensing data generated by a fingerprint sensor contains a personal identification password or biometric information, and therefore the sensitivity level of the sensing data can be considered to be second level. The sensitivity level of the second level sensitive data is higher than that of the first level sensitive data. In the embodiment, the sensitivity levels are distinguished according to, for example, whether the content of the sensing data contains the biometric information.

In step S107, whether to perform local security verification or not is determined according to the corresponding sensitivity level. If the sensing data is first level sensitive data, then step S108 is executed to encrypt the sensing data; and then step S110 is executed to package and transmit the encrypted data out of the display screen. If the sensing data is second level sensitive data, then step S109 is executed to perform local security verification on the sensing data; and then step S110 is executed to package and transmit the verification result out of the display screen.

In step S109, local security verification is performed on the sensing data. Before the step, the operating system can be requested to provide the feature data in advance, and the feature data obtained from the operating system can be stored in the flash memory 244. In a preferred embodiment, the integrated control chip 210 can locally acquire and generate feature data, and can store the feature data in the flash memory 244. The feature data comprises a PIN code, a fingerprint template, an iris feature and the like.

In step S110, different types of data are packaged and transmitted out of the display screen. The packaged data in the step comprises any one of the sensing data, the encrypted data and the verification result. The data packaging, for example, comprises: adding a start flag/bit and a type identifier before the data content to be packaged, and adding an end flag/bit and a check flag/bit after the data content to be packaged.

In the above-described method, different types of sensing data are processed differently. For the non-sensitive data, the integrated control chip 210 directly transmits the sensing data out of the display screen; for the first level sensitive data, the integrated control chip 210 is configured to encrypt and then transmit the encrypted sensing data out of the display screen; for the second level sensitive data, the integrated control chip 210 locally performs security verification, compares the sensing data with the feature data to obtain the verification result, and transmits the verification result out of the display screen.

The data will be transmitted from the driver chip of the display screen to the processor on the main board, and is processed by the operating system to acquire data content. The operating system can determine the data content to be one of the sensing data, the encrypted data and the verification result according to the type identifier.

With reference to FIG. 4, when the method is applied to an electronic device, the processor on the main board 410 and the processor in the integrated control chip 210 are respectively used for the operating system and security verification. The operating system can only acquire the verification result from the integrated control chip 210, but cannot acquire the sensitive data, thus facilitating improvement of security.

It should be explained that the relationship terms, such as “first” and “second”, are used herein only for distinguishing one entity or operation from another entity or operation but do not necessarily require or imply that there exists any actual relationship or sequence of this sort between these entities or operations. Furthermore, terms “comprising”, “including” or any other variants are intended to cover the non-exclusive including, thereby making that the process, method, merchandise or device comprising a series of elements comprise not only those elements but also other elements that are not listed explicitly or the inherent elements to the process, method, merchandise or device. In the case of no more limitations, the element limited by the sentence “comprising a . . . ” does not exclude that there exists another same element in the process, method, merchandise or device comprising the element.

The embodiments in accordance with the present disclosure, as described above, are not described in detail, and are not intended to limit the present disclosure to be only the described particular embodiments. Obviously, various modifications and variations can be made according to the descriptions above, including but not limited to the variations to a local structure of a circuit and the replacement to the type or model of an element. These embodiments have been chosen and described in detail by the specification to explain the principles and embodiments of the present disclosure so that those skilled in the art can make good use of the present disclosure and the modified use based on the present disclosure. The disclosure is to be limited only by the scope of the appended claims and the appended claims and equivalents thereof.

1. An integrated control device, comprising:
a display unit, configured to provide display driving signals to a display screen;
a sensor unit, configured to provide a driving signal to at least one sensor, receive a sensing signal from the at least one sensor, and convert the sensing signal into sensing data;
a processor, configured to control the display unit and the sensor unit,
wherein the processor performs local security verification to at least a part of the sensing data, and a verification result is output by the integrated control device.

2. The integrated control device according to claim 1, further comprising: a non-volatile memory configured to store feature data,
wherein the processor is configured to perform security verification by comparing the sensing data with the feature data.

3. The integrated control device according to claim 1, wherein the display unit is used to drive a liquid crystal display screen, and comprises:
a display and graphic interface configured to receive display data;
a display controller configured to generate image data according to the inputted display data;
a graphic engine configured to provide an optimized image to the at least one sensor;
a gate driving module configured to generate gate voltages to turn on multiple rows of thin film transistors selectively;
a source driving module configured to generate gray scale voltages according to the image data, and apply the gray scale voltages via the selected thin film transistors which are under turn-on state; and
a timing controller configured to control output time of the gate voltages and the gray scale voltages, for selectively turning on the multiple rows of thin film transistors in a scanning manner during consecutive image frame periods.

4. The integrated control device according to claim 3, wherein the display unit further comprises:
a common voltage driving module configured to generate a common voltage; and
a gamma reference module configured to store a gamma correction curve, and provide a correction signal to the source driving module for correcting the gray scale voltages, so as to satisfy a nonlinear requirement of human eyes under luminance change.

5. The integrated control device according to claim 1, wherein the display unit is used to drive an AMOLED display screen, and comprises:
a display and graphic interface, configured to receive display data;
a display controller, configured to generate image data according to the inputted display data;
a graphic engine, configured to supply an optimized image corresponding to the at least one sensor;
a row driving module configured to generate gate voltages to selectively turn on multiple rows of thin film transistors;
a column driving module configured to generate gray scale voltages according to the image data, and apply driving currents corresponding to the gray scale voltages via the selected thin film transistors which are under turn-on state; and
a timing controller, configured to control output time of the gate voltages and the gray scale voltages, for selectively turning on the multiple rows of thin film transistor in a scanning manner during consecutive image frame periods.

6. The integrated control device according to claim 5, wherein the display unit further comprises:
a gamma reference module configured to store a gamma correction curve, and provide a correction signal to the column driving module for correcting the gray scale voltages, so as to satisfy a nonlinear requirement of human eyes under luminance change.

7. The integrated control device according to claim 1, wherein the at least one sensor is selected from at least one of a touch sensor, a fingerprint sensor, a palm print sensor, an acoustic sensor and an optical sensor; and the sensing data is used to represent at least one of a two-dimensional code, a touch position, a fingerprint, a palm print, a voice print and an iris.

8. The integrated control device according to claim 7, wherein the at least one sensor is a touch sensor; and the sensor unit comprises:
a touch logic module configured to provide touch driving signals, receive touch sensing signals, and performing amplification and digital-to-analog conversion on the received touch sensing signal to generate the sensing data; and
a touch interface configured to transmit the sensing data and one of the verification result and encrypted data generated according to the sensing data out of the integrated control device.

9. The integrated control device according to claim 7, wherein the integrated control device is a single chip.

10. A display system, comprising:
a display screen configured to display an image according to display data;
at least one sensor for acquiring a sensing signal by interacting with a user; and
the integrated control device according to claim 1.

11. The display system according to claim 10, wherein the display screen is selected from any one of a liquid crystal display screen, an LED display screen, an AMOLED display screen, a quantum dot display screen, electronic paper and a Micro-LED display screen.

12. The display system according to claim 10, wherein the at least one sensor is located inside or outside the display screen.

13. An electronic device, comprising:
at least one sensor, configured to acquire a sensing signal by interacting with a user; and
the integrated control device according to claim 1.

14. The electronic device according to claim 13, wherein the electronic device is selected from any one of a mobile phone, a tablet computer, a notebook computer, a VR device, an AR device, a watch, an automobile and a bicycle.

15. A security verification method, comprising:
acquiring a sensing signal from at least one sensor;
acquiring sensing data from the sensing signal; and
encrypting at least a part of the sensing data to obtain encrypted data, or performing local security verification to obtain a verification result.

16. The method according to claim 15, wherein before the step of performing local security verification, the method further comprises:
acquiring an identifier from the at least one sensor; and
determining whether the sensing data is sensitive data according to the identifier,
wherein at least a part of the sensing data is sensitive data.

17. The method according to claim 15, wherein before the step of performing local security authentication, the method further comprises:
setting a display screen to operate under a predetermined operating status;
detecting the operating status of the display screen; and
distinguishing the sensing data into sensitive data and non-sensitive data according to the detected operating status.

18. The method according to claim 17, wherein before the step of performing local security verification, the method further comprises:
distinguishing the sensing data into first level sensitive data and second level sensitive data according to sensitivity levels, wherein a sensitivity level of the second level sensitive data is higher than that of the first level sensitive data,
wherein at least a part of the sensing data is the second level sensitive data.

19. The method according to claim 17, further comprising: packaging the sensing data, the encrypted data and the verification result into a data packet, and transmitting the data packet.

20. The method according to claim 19, wherein a start flag and a type identifier are added before data content to be packaged, and an end flag and a check flag are added after the data content to be packaged.

21. The method according to claim 15, wherein the security verification comprises: comparing the sensing data with feature data to obtain a comparison result.

22. The method according to claim 15, wherein before the step of performing local security verification, the method further comprises: locally obtain and generate the feature data by use of the at least one sensor.
